(19) United States
(12) Patent Application Publication
(10) Pub. No.: US 2005/0010361 A1
(43) Pub. Date: Jan. 13, 2005

(54) Apparatus, system, method, and program for wireless GPS surveying

(76) Inventors: Michael C. Runkel, Greenwood, IN (US); John M. Kantner, Indianapolis, IN (US)

Correspondence Address: BARNES & THORNBURG, 11 SOUTH MERIDIAN, INDIANAPOLIS, IN, 46204, US

(21) Appl. No.: 10/615,648

(22) Filed: Jul. 9, 2003

(51) Int. Cl. G01C 21/26

(52) U.S. Cl. 701/213; 701/216

(57) ABSTRACT

An apparatus, system, method, and program for wireless GPS surveying is disclosed. The system includes a surveying rover which receives GPS correction data from a wireless network. The wireless network includes such wireless networks as a digital wireless network and a circuit switched analog network.

### FIELD OF THE DISCLOSURE

The present disclosure relates generally to a GPS surveying system, and more particularly to a GPS surveying system using a wireless network.

### BACKGROUND OF THE DISCLOSURE

Global Positioning System (hereinafter sometimes GPS) survey systems are used to survey selected locations, for example, plots of land, by gathering topographical measurements and data about the selected location. GPS survey systems utilize GPS data to increase the accuracy of the location surveys. Typical GPS survey systems include a number of elements which communicate with each other during the survey process. For increased mobility and utility, typical GPS survey systems use wireless communications to facilitate the communications between the individual elements.

A typical wireless GPS surveying system includes a stationary element, commonly known as a surveying base station, and a number of mobile remote elements, commonly known as surveying rovers. The surveying base station includes a GPS receiver for receiving GPS data from a GPS source such as a number of GPS satellites. The base station is positioned at a strategic location with a known coordinate value (e.g., having a known longitude and latitude value). Due to atmospheric conditions and other anomalies, the GPS data received by the surveying base station may vary from the known coordinate value of the location of the base station. In particular, the GPS coordinate value of the location on which the surveying base station is positioned (as determined by the surveying base station) may vary from the known coordinate value of such a location. Accordingly, the surveying base station calculates GPS correction data indicative of the difference between the location of the base station as determined from the received GPS data and the known coordinate value of the location. The surveying base station also includes a transmitter used to transmit the GPS correction data to the various surveying rovers using wireless communications. In contemporary GPS survey systems, the wireless communications consist of Ultra High Frequency (hereinafter sometimes UHF) communications.

A typical surveying rover includes a GPS receiver for receiving GPS data from a GPS source (e.g., a number of GPS satellites) and a UHF receiver for receiving the GPS correction data from the surveying base station. Due to the aforementioned atmospheric conditions and other anomalies, the GPS data received by the surveying rover may be somewhat inaccurate. To improve the accuracy of the location survey, the surveying rover uses the GPS data received from the GPS source and the GPS correction data received from the surveying base station to produce improved survey measurements and data during the survey process. For example, in some implementations, the surveying rover sums the GPS data received from the GPS source and the GPS correction data to produce survey data having improved accuracy relative to the GPS data received from the GPS source.

A typical survey process includes positioning a number of surveying rovers at strategic locations in and around the survey location. The surveying rovers receive the GPS data from the GPS satellites and the GPS correction data from the surveying base station. Using the GPS data and GPS correction data, the surveying rovers produce survey data. In some applications, the surveying rovers may be repeatedly repositioned in and around the survey location in order to produce survey data from a number of selected positions. However, the survey locations and selected positions in and around the survey locations are limited by the positioning of the surveying base station. In particular, the distance from the surveying base station at which the surveying base station can communicate with the surveying rovers is limited to the transmission distance of the UHF communications used to transmit the GPS correction data from the surveying base station to the surveying rovers. Due to a variety of interferences, atmospheric conditions, and other limiting factors, the transmission distance of the UHF communications may be inadequate to reach the entirety of the survey location. Accordingly, the distance from the surveying base station at which the surveying base station can communicate with the surveying rovers is a consideration in the development of wireless GPS survey systems.

### SUMMARY OF THE DISCLOSURE

According to one illustrative embodiment, there is provided a method of operating a surveying rover. The method comprises the step of receiving GPS correction data from a digital wireless network.

According to another illustrative embodiment, there is provided a method of operating a surveying rover. The method comprises the step of receiving GPS correction data from a circuit switched wireless network.

In a more specific illustrative embodiment, there is provided a method of operating a surveying rover. The method comprises the steps of receiving GPS correction data formatted for an Internet Protocol transmission from a digital wireless network and generating a serial output based on the GPS correction data.

According to a further illustrative embodiment, there is provided a communications assembly for a surveying rover. The communications assembly comprises a computing device and a wireless transceiver electrically coupled to the computing device. The wireless transceiver is configured to receive GPS correction data from a digital wireless network.

In another specific illustrative embodiment, there is provided a surveying rover. The surveying rover comprises a GPS receiver configured to receive GPS data from a satellite and a wireless transceiver configured to receive GPS correction data from a digital wireless network.

In yet another specific illustrative embodiment, there is provided a method of determining a GPS coordinate of a location. The method comprises receiving GPS data with a base station, generating GPS correction data based on the GPS data, transmitting the GPS correction data across a network, accessing the network through a digital wireless network, retrieving the GPS correction data from the digital wireless network, and calculating the GPS coordinate of the location based on the GPS correction data.

In a further specific illustrative embodiment, there is provided a communications assembly for a surveying rover. The communications assembly comprises a wireless transceiver, a processor electrically coupled to the wireless transceiver, and a memory device electrically coupled to the processor. The memory device has stored therein a plurality of instructions, which when executed by the processor, causes the processor to operate the wireless transceiver to receive GPS correction data formatted for an Internet Protocol transmission from a digital wireless network and generate a serial output based on the GPS correction data.

In yet a further specific illustrative embodiment, there is provided an article comprising a computer-readable signal-bearing medium having a plurality of instructions, which when executed by a processor, causes the processor to operate a wireless transceiver to receive GPS correction data formatted for an IP transmission from a digital wireless network and generate a serial output based on the GPS correction data.

The above and other features of the present disclosure will become apparent from the following description and the attached drawings.

### BRIEF DESCRIPTION OF THE DRAWINGS

FIG. 1 is a diagrammatic view of a surveying system which incorporates the features of the present disclosure therein;

FIG. 2 is a diagrammatic view of a surveying rover of the system of FIG. 1;

FIG. 3 is a block diagram showing the communications assembly of the surveying rover of FIG. 2 in greater detail; and

FIG. 4 is a process flow diagram of a software routine executed by the communications assembly of FIG. 3.

### DETAILED DESCRIPTION OF AN ILLUSTRATIVE EMBODIMENT

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the disclosure.

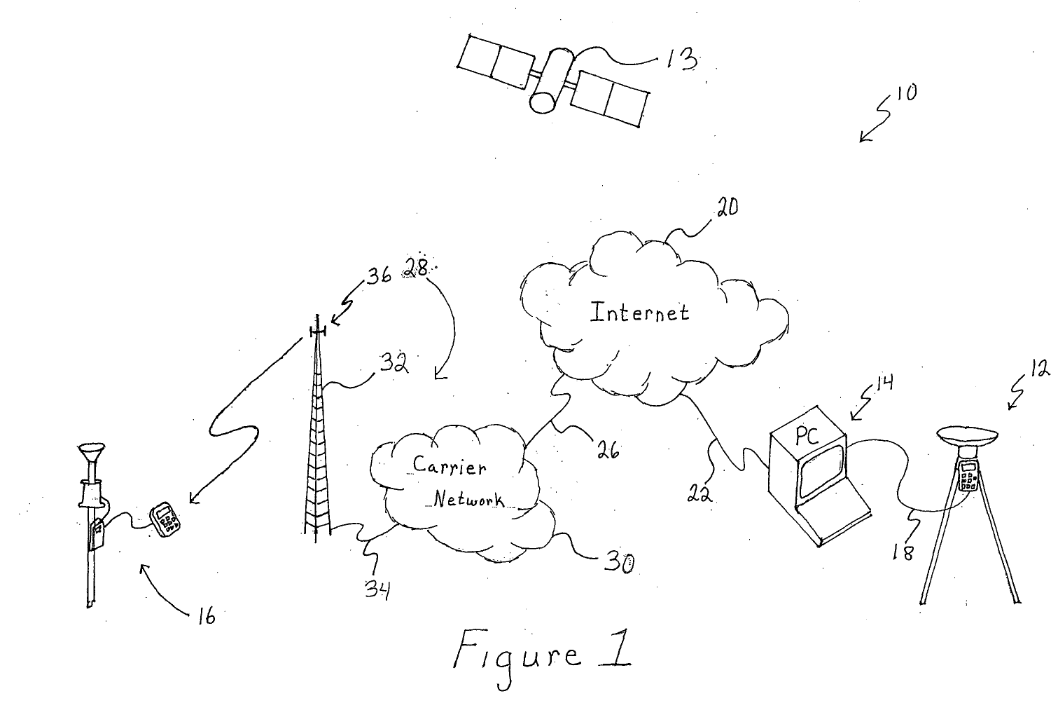

In one illustrative embodiment, a wireless GPS survey system 10 includes a surveying base station 12, a computer 14, and a surveying rover 16, as shown in FIG. 1. The base station 12 is electrically coupled to the computer 14 via a number of electrical interconnects 18. Illustratively, the interconnects 18 are serial cables which facilitate the transmission of data using a serial transmission. However, in other embodiments, the interconnects 18 may be parallel interconnects, Universal Serial Bus (hereinafter sometimes USB) interconnects, or any other type of interconnects useful in operably coupling the base station 12 and the computer 14. In addition, the interconnects 18 may be embodied as wires, cables, fiber optic cables, and other types of interconnects.

The surveying base station 12 includes a GPS receiver which is operable to receive GPS data, such as coordinate values, from a GPS source such as a number of GPS satellites 13. The base station 12 is positioned at a strategic location with a known coordinate value. For example, the base station 12 may be positioned on top of a building or similar structure with a known coordinate value. The coordinate value of the strategic location may be obtained by measuring the distance of the strategic location from known monuments having a coordinate value established by the National Geodetic Survey, by averaging the GPS data received by the base station 12 over a predetermined period of time, from a National Geodetic Survey publication, or from other available coordinate value sources. The base station 12 receives GPS data from the GPS satellites 13, however, due to atmospheric conditions and other anomalies, the determination of the base station's 12 location based on GPS data received from the GPS satellites 13 may vary from the known coordinate value of the location of the base station 12. Accordingly, the base station 12 calculates GPS correction data based on the known coordinate value of the location of the base station 12 and the location of the base station as determined based on GPS data received from the GPS satellites 13. In one exemplary embodiment, the GPS correction data is calculated based on the difference between the known coordinate value of the location of the base station 12 and the location of the base station 12 as determined by GPS data received from the GPS source. In other embodiments, additional or more complex calculations may be used to calculate the GPS correction data.

The surveying base station 12 transmits the GPS correction data to the computer 14 via the interconnects 18. Illustratively, the base station 12 periodically transmits the GPS correction data to the computer 14. For example, the base station 12 may transmit the GPS correction data in predetermined intervals such as about every two seconds. However, in other embodiments, the base station 12 may transmit the data at other periods, transmit the data based on a received input, or transmit the data based on some other type of trigger event. Moreover, the base station 12 may be configured to continuously transmit GPS correction data to the computer 14.

The computer 14 is coupled to a network 20 via a number of interconnects 22. The computer 14 is a computing device capable of receiving the GPS correction data from the base station 12 and transmitting the GPS correction data across the network 20 via the interconnects 22. The computer 14 may be a contemporary computer, such as a Personal Computer (PC), having a processor, memory device, and an array of input/output devices. Alternatively, the computer 14 may be a terminal or client computer electrically coupled to other computers 14 in a server-client relationship. Additionally, the computer 14 may be a self-contained computing device being pre-programmed with an instruction set that allows the computer 14 to receive and transmit the GPS correction data and having few or no user input devices such as a keyboard.

The computer 14 formats or packages the GPS correction data prior to the transmission of the data across the network 20. In particular, the computer 14 formats the GPS correction data according to the transmission protocol used by the network 20. In the illustrative embodiment described herein, the computer 14 formats the data for an Internet Protocol (hereinafter sometimes IP) transmission, which is a formatting process well known in the art. Alternatively, the computer 14 may format the data for other types of transmissions suitable for the particular network 20. For example, if the network 20 is a proprietary network such a wide area network, the computer 14 may format the data using the transmission protocol used by the proprietary wide area network. Nonetheless, the GPS correction data is formatted for transmission by the computer 14 and transmitted across the network 20.

In the illustrative embodiment described herein, the network 20 is a publicly-accessible global network such as the Internet. In other embodiments, the network 20 may be a local area network (hereinafter sometimes LAN), a wide area network (hereinafter sometimes WAN), an intranet, or other limited access network. The GPS correction data is propagated across the network 20 by internal devices of network 20 such as computers, routers, switches, and hubs by a transmission using a suitable transmission protocol. The transmission protocol utilized by the network 20 may vary depending on the type of network. For example, the network 20 may use Internet Protocol, Transmission Control Protocol (hereinafter sometimes TCP), Stream Control Transmission Protocol (hereinafter sometimes SCTP), User Datagram Protocol (hereinafter sometimes UDP), a combination of protocols, or other types of protocols including proprietary transmission protocols.

The GPS correction data is propagated across the network 20 to a wireless network 28. The wireless network 28 includes a carrier network 30 electrically coupled to the network 20 via a number of interconnects 26 and a number of carrier towers 32, each electrically coupled to the carrier network 30 via a number of interconnects 34. In a known manner, each of the carrier towers 32 includes a number of antennas (not shown). The carrier network 30 may include such elements as Mobile Telephone or Telecommunications Switch Offices (hereinafter sometimes MTSO), carrier base stations, interconnections operable to couple the various elements of the wireless carrier network 30 (either via wired or wireless connections), and additional towers, antennas, and other communication devices useful in propagating data across the wireless network 28. Additionally, in some embodiments, the carrier network 30 may include portions of the local Public Switch Telephone Network (hereinafter sometimes PSTN).

The wireless network 28 propagates the GPS correction data across the carrier network 30 and transmits the GPS correction data to the surveying rover 16 via one, or in some implementations a number of, the towers 32 using a wireless transmission from the towers 32 to the rover 16. In some embodiments, the wireless network 28 is an analog wireless network such as an Advanced Mobile Phone Service (hereinafter sometimes AMPS) network, a Narrowband Advanced Mobile Phone Service (hereinafter sometimes NAMPS) network, or other analog wireless network. The wireless network 28 may be a circuit switched analog wireless network. In such embodiments, the wireless transmissions from the network 28 may be one of a number of analog transmissions including Frequency Division Multiple Access (hereinafter sometimes FDMA) transmissions.

In other embodiments, the wireless network 28 may be embodied as a digital wireless network such as a Global System for Mobile Communications (hereinafter sometimes GSM) network, a Personal Communications Systems (hereinafter sometimes PCS) network, a Digital Advanced Mobile Phone Service (hereinafter sometimes DAMPS) network, or other digital wireless network which, in some implementations, may use, communicate with, or rely on portions of an analog wireless network such as an AMPS network. In the case of a digital network, the wireless network 28 may be embodied as a circuit switched digital wireless network, a packet switched wireless network, or other type of digital wireless network including proprietary digital networks such as the Integrated Digital Enhanced Network (hereinafter sometimes iDEN). In embodiments including digital wireless networks, the wireless transmissions used by the network 28 may be one of a number of digital transmissions including Time Division Multiple Access (hereinafter sometimes TDMA) transmissions and Code Division Multiple Access (hereinafter sometimes CDMA) transmissions. In the illustrative embodiment, the wireless transmission used by the network 28 includes a Code Division Multiple Access 1XRTT transmission.

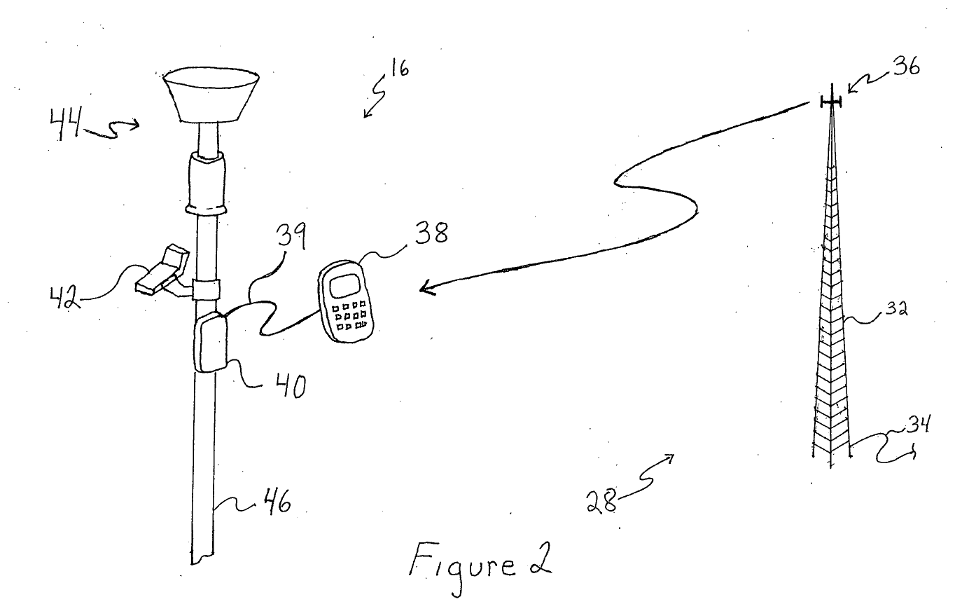

The surveying rover 16 receives the GPS correction data via the wireless transmission, such as a CDMA transmission, from the wireless network 28. In the illustrative embodiment, the surveying rover 16 includes a communications assembly 38, a GPS receiver 40, a rover controller 42, and a GPS antenna 44, as illustrated diagrammatically in FIG. 2. Each of the communications assembly 38, receiver 40, controller 42, and antenna 44 is secured or otherwise coupled to a rod 46.

The communications assembly 38 is configured to receive wireless transmissions from the wireless network 28. In particular, the communications assembly 38 receives the GPS correction data formatted in a protocol suitable for transmission across the Internet 20 and the wireless network 28. In the illustrative embodiment described herein, the communications assembly 38 receives the GPS correction data formatted for an Internet Protocol transmission from the wireless network 28. The communications assembly 38 converts the GPS correction data formatted for an Internet Protocol transmission, or other transmission protocol based on the type of the network 20, to GPS correction data formatted for a serial transmission. In some embodiments, the IP transmission to serial transmission conversion process includes removing the IP header and similar data from the GPS correction data. The communications assembly 38 transmits the GPS correction data formatted for a serial transmission to the GPS receiver 40 via a number of serial interconnects 39. The serial interconnects 39 electrically couple the communications assembly 38 and the receiver 40 and include such interconnects as cables, wires, or other interconnects suitable for serial transmissions such as an RS-232 cable. However, in other embodiments, the interconnects 39 may be parallel interconnects, USB interconnects, wireless interconnects such as a Bluetooth interconnect, or other types of wired or wireless interconnects.

The GPS antenna 44 and the GPS receiver 40 cooperate to receive GPS data from the GPS satellites 13. The GPS data received by the receiver 40 is indicative of the location of the surveying rover 16. Accordingly, the GPS data will vary as the location of the surveying rover 16 is varied. However, the GPS data may suffer from similar inaccuracies as the GPS data received by the surveying base station 12 due to atmospheric conditions and other anomalies. The surveying rover 16 is unable to compensate for these inaccuracies in the GPS data by a calculation process similar to the calculation process used by the surveying base station 12 because the exact coordinate value of the location of the surveying rover 16 is typically unknown. Additionally, the surveying rover 16 is repeatedly relocated during the survey process.

The surveying rover 16 compensates for the inaccuracies in the GPS data received by the receiver 40 from the GPS satellites 13 by calculating a GPS location coordinate based on the GPS data received from the GPS satellites 13 and the GPS correction data received from the wireless network 28 via the communications assembly 38. In the illustrative embodiment, the GPS location coordinate of the rover 16 is calculated by summing, differencing, or otherwise comparing the GPS data received by the receiver 40 and antenna 44 from the GPS satellites 13 and the GPS correction data received by the communications assembly 38 via the wireless network 28. In other embodiments, the GPS location coordinate of the rover 16 may be calculated using an alternative mathematical algorithm or process based on the GPS data and the GPS correction data.

The rover controller 42 communicates with the receiver 40 to receive the GPS location coordinate of the rover 16. The rover controller 42 communicates with the receiver 40 via a number of wired interconnects or by a wireless interconnect such as a Bluetooth wireless interconnect, UHF wireless interconnect, or other type of wireless interconnect. The controller 42 records the GPS location coordinate for the particular location at which the rover 16 is presently located. The rover 16 may then be repositioned at a new location, calculate another GPS location coordinate, and store the new GPS location coordinate in the controller 42. Once the survey process is completed, the controller 42 may produce a list of GPS location coordinates, a graphical representation of the locations, and other data useful for the survey process and surveying decisions relating to the surveyed location.

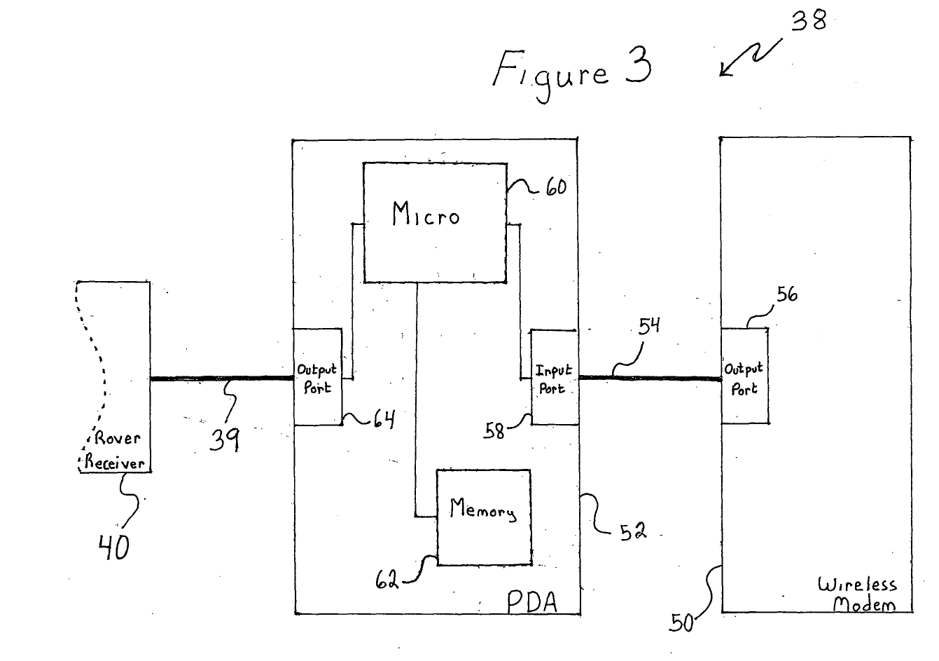

Referring now to FIG. 3, in the illustrative embodiment described herein, the communication assembly 38 includes a wireless transceiver 50 and a computing device 52. In some embodiments, the wireless transceiver 50 and the computing device 52 are separate devices such as a wireless modem and a PDA, respectively. In other embodiments, the wireless transceiver 50 and the computing device 52 may be integrated in a single device (i.e. communication assembly 38) such as a PDA cellular phone or the like. The wireless transceiver 50 is electrically coupled to the computing device 52 via a number of interconnects 54. The interconnects 54 may be parallel interconnects, serial interconnects, or other types of interconnects commonly used to enable communication between a wireless transceiver and a computing device. Such interconnects may be embodied as connectors, couplers, wires, and/or cables.

The wireless transceiver 50 is configured to receive the GPS correction data formatted for an IP transmission from the wireless network 28. Accordingly, the wireless transceiver 50 is configured to receive the transmission type used by the wireless network 28. For example, if the wireless network 28 is a digital wireless network using a CDMA transmission, the wireless transceiver 50 is configured to receive the GPS correction data formatted for an IP transmission from such a CDMA wireless network. Illustratively, the wireless transceiver 50 is a wireless cellular modem. One such wireless cellular modem is an AirCard 555 Wireless Network Card which is commercially available from Sierra Wireless, Inc. of Richmond, British Columbia, Canada. However, in other embodiments, the wireless transceiver 50 may be a cellular, PCS, GSM, or other type of mobile phone, a wireless network card, or other transceiver device suitable for communicating with the wireless network 28. Additionally, in some embodiments, the wireless transceiver 50 is configured as a receiver only. In such embodiments, the wireless transceiver 50 is operable to receive the GPS correction data formatted for an IP transmission from the wireless network 28, but is not operable to transmit data to the wireless network 28.

The wireless transceiver 50 includes an output port 56. In some embodiments, the output port 56 may be an output register, output buffer, or other output device or architecture suitable for transmitting data from the transceiver 50. The GPS correction data formatted for an IP transmission is transmitted from the receiver 50 to the computing device 52 via the output port 56 and the interconnects 54. The computing device 52 includes an input port 58 which receives the GPS correction data formatted for an IP transmission from the transceiver 50. The input port 58 may be an input register, input buffer, or other input device or architecture suitable for receiving data transmission from the wireless transceiver 50.

The computing device 52 also includes a processor 60, a memory device 62, and a serial output port 64. The processor 60 is electrically coupled to the input port 58, the output port 64, and the memory device 62. The device 52 may also include other devices useful in a computing device such as drivers, registers, buffers, digital signal processors, and the like. Illustratively, the computing device 52 is embodied as a Personal Digital Assistant (hereinafter sometimes PDA). One such PDA is a Compaq iPAQ Pocket PC H3955 which is commercially available from Hewlett-Packard Company of Palo Alto, Calif. In addition to PDA's, other computing devices may be used as the computing device 52 such as laptop computers, PDA mobile phones, and similar computing devices suitable for receiving data from the wireless transceiver 50, processing the data, and serially transmitting the data to the survey receiver 40. It should be appreciated that in some of such implementations, the computing device may function as both the computing device 52 and the wireless transceiver 50 (e.g., the PDA mobile phone or laptop computer equipped with a wireless modem).

The processor 60 and memory device 62 cooperate to convert the GPS correction data formatted for an IP transmission received from the wireless transceiver 50 to GPS correction data formatted for a serial transmission. In particular, the memory device 62 has stored therein a plurality of instructions in the form of a software routine which performs such a conversion. The memory device 62 may be Random Access Memory (hereinafter sometimes RAM), Read Only Memory (hereinafter sometimes ROM), flash or erasable memory such as Erasable Programmable ROM (hereinafter sometimes EPROM) and Electrically Erasable Programmable ROM (hereinafter sometimes EEPROM), and other memory devices.

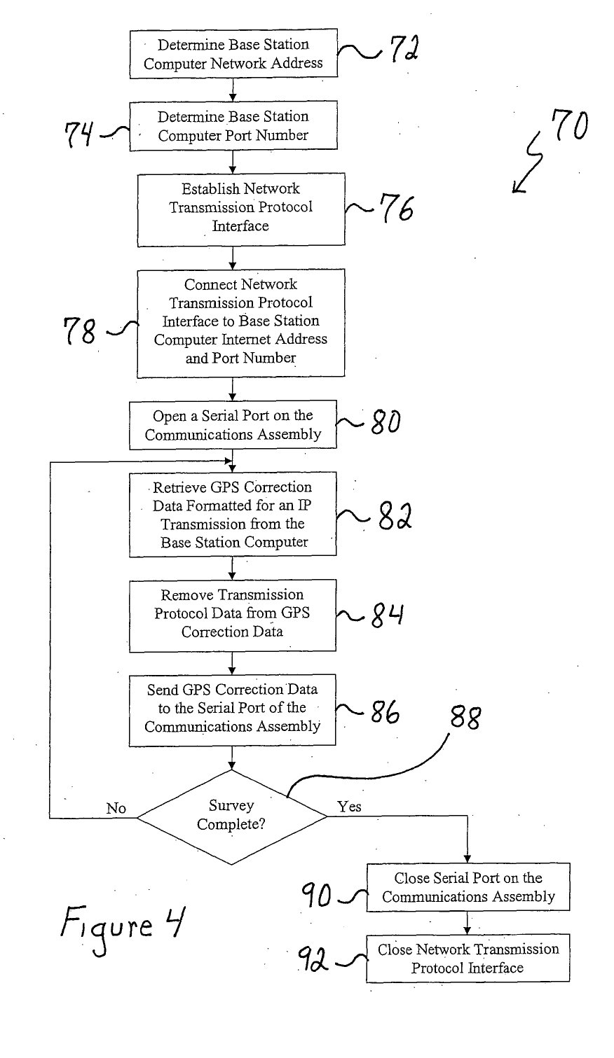

Due to the adaptable nature of programming languages, there are many embodiments of the software routine stored in the memory device 62 for receiving GPS correction data formatted for an IP transmission, converting the GPS correction data to a serial transmission format, and serially transmitting the GPS correction data formatted for a serial transmission. One embodiment of such a software routine 70 is shown in the process flow diagram in FIG. 4.

The routine 70 initiates by determining the network address of the computer 14 electrically coupled to the base station 12 in process step 72. The network address of the computer 14 may be determined by querying the user for the network address or the network address, if known, may be coded in the routine. Illustratively, the network address of the computer 14 is an Internet address. However, other types of network addresses may be used depending upon the type of the network 20 utilized and the type of transmission protocol used by the network 20.

The port number of the computer 14 is determined in process step 74. Again, the port number of the computer 14 may be determined by querying the user for the port number or the port number, if known, may be coded in the routine. Typical port numbers may range from 1 to 65,535. However, other port numbers may be used in some implementations, for example, implementations including a computer 14 having a proprietary architecture. It should be appreciated that process step 74 and process step 72 may be completed in any order.

A network transmission protocol interface is established and connected to the computer 14 in process steps 76 and 78, respectively. The network transmission protocol interface is a software device used to provide a level of abstraction over the transmission protocol. The interface supports the interaction, such as sending and receiving data, of the communications assembly 38 with the network 20 and the computer 14 without the necessity of low level transmission protocol programming. The interface is established by an appropriate calling or opening instruction which varies according to the type of interface used. The interface is connected to the computer 14 across the network 20 via binding to the port number of the computer 14. In the illustrative embodiment, a socket, in particular a Winsock, is created and connected to the appropriate port of the computer 14. In other embodiments, other types of sockets or network transmission protocol interfaces may be used. For example, in embodiments with a private network 20 such as a LAN, a proprietary interface may be used. Additionally, in some implementations, an interface may not be used and the software routine 70 will include the appropriate low level transmission protocol commands to properly interface and interact with the network 20 and the computer 14.

A serial port, such as a communications port, is opened on the computing device 52 in process step 80. The opening of a serial port on the computing device 52 facilitates serial data transmission and provides connectivity to receiving devices such as the receiver 40 of the rover 16. Illustratively, the serial port opened on the computing device 52 corresponds to the serial output port 64 of the computing device 52 which is electrically coupled to the receiver 40 via a number of serial interconnects 39 as illustrated in FIG. 3.

The GPS correction data formatted for an IP transmission is retrieved from the computer 14 in process step 82. As described above, the communications assembly 38 is connected to the computer 14 across the network 20 via the transmission protocol interface. The communications assembly 38 retrieves the GPS correction data, which has been formatted for an IP transmission by the computer 14, from the computer 14 via a retrieve command native to the interface. For example, the Winsockl.GetData command may be used in those embodiments utilizing a WinSock transmission protocol interface. However, the specific format of the retrieve command may vary according to the transmission protocol interface used. The interface performs all necessary networking functions required to transfer the GPS correction data formatted for an IP transmission from the computer 14 to the communications assembly 38. The retrieve command may also include a number of low level transmission protocol commands in those embodiments which do not include a transmission protocol interface.

The Internet Protocol transmission data, such as the IP header and footer data, is removed from the GPS correction data in process step 84. In those embodiments including a network 20 utilizing a different type of transmission protocol, such as UDP, the transmission protocol data, such as the UDP header and footer data, is removed form the GPS correction data. In some embodiments, the transmission protocol data is removed from the GPS correction data by the communications assembly 38 network hardware such as the network adapter or by the communications assembly 38 network software such as the network driver. Nonetheless, the transmission protocol data is removed from the GPS correction data so as to leave the GPS correction data in a format similar to the GPS correction data format prior to the packaging and formatting of the GPS correction data for an IP transmission by the computer 14.

In process step 86, the GPS correction data is sent to the serial port of the computing device 52 which was opened in the process step 80. Sending the GPS correction data to the serial port initiates the serial transmission of the GPS correction data from the computing device 52, across the serial interconnects 39, and to the receiver 40 of the rover 16. The instructions used to send the GPS correction data to the serial port may vary according to the programming language used to construct the software routine 70. In some programming languages, such as Visual Basic eMbedded Visual Tools 3.0—2002 Edition which is commercially available from Microsoft of Redmond, Wash., a Comml.Output instruction may be used to send the GPS correction data to the serial port and initiate the serial transmission of the GPS correction data.

The user is queried in process step 88 to determine if the survey is complete. If additional locations are to be surveyed or if the survey is not otherwise complete, the routine 70 loops back to process step 82 so that additional GPS correction data may be obtained. If, however, the survey is complete, the serial port opened in process step 80 and the network transmission protocol interface established in process step 76 are closed in process steps 90 and 92, respectively, thus terminating the connection to the computer 14 established by the transmission protocol interface. The associated GPS enhanced survey data for the surveyed location may then be stored within the communications assembly device 38, for example in the memory device 62, or controller 42 of the rover 16 for later retrieval and analysis.

As described herein, the concepts of the present disclosure provide for the transmission of GPS correction data across a relatively large area. For example, GPS correction data may be obtained by the surveying rover at any location in which the rover can obtain a signal from the wireless network.

There are a plurality of advantages of the present disclosure arising from the various features of the apparatus, methods, systems, and programs described herein. It will be noted that alternative embodiments of each of the apparatus, methods, systems, and programs of the present disclosure may not include all of the features described yet still benefit from at least some of the advantages of such features. Those of ordinary skill in the art may readily devise their own implementations of apparatus, methods, systems, and programs that incorporate one or more of the features of the present invention and fall within the spirit and scope of the present disclosure as defined by the appended claims.

For example, although the software concepts disclosed herein are described as already being loaded or otherwise maintained on a computing device (e.g., either a client or server machine), it should be appreciated that the present disclosure is intended to cover the software concepts described herein irrespective of the manner in which such software concepts are disseminated. For instance, the software concepts of the present disclosure, in practice, could be disseminated via any one or more types of a recordable data storage medium such as a modulated carrier signal, a magnetic data storage medium, an optical data storage medium, a biological data storage medium, an atomic data storage medium, and/or any other suitable storage medium.

1. A method of operating a surveying rover, the method comprising the step of receiving GPS correction data from a digital wireless network.

2. The method of claim 1, wherein the receiving step comprises receiving GPS correction data from a circuit switched digital wireless network.

3. The method of claim 1, wherein the receiving step comprises receiving GPS correction data from a circuit switched digital wireless network using a Code Division Multiple Access transmission.

4. The method of claim 1, wherein the receiving step comprises receiving GPS correction data from a circuit switched digital wireless network using a Time Division Multiple Access transmission.

5. The method of claim 1, wherein the receiving step comprises receiving GPS correction data from a packet switched digital wireless network.

6. The method of claim 1, wherein the receiving step comprises receiving GPS correction data from a packet switched digital wireless network using a Code Division Multiple Access transmission.

7. The method of claim 6, wherein the Code Division Multiple Access transmission comprises a Code Division Multiple Access 1XRTT transmission.

8. The method of claim 1, wherein the receiving step comprises receiving GPS correction data from a Personal Communication Services digital wireless network.

9. The method of claim 1, wherein the receiving comprises receiving GPS correction data from a Global System for Mobil Communications digital wireless network.

10. The method of claim 1, wherein the receiving step comprises receiving GPS correction data from a digital wireless network using a Code Division Multiple Access transmission.

11. The method of claim 10, wherein the Code Division Multiple Access transmission comprises a Code Division Multiple Access 1XRTT transmission.

12. The method of claim 10, wherein the receiving step further comprises receiving GPS correction data formatted for an Internet Protocol transmission from the digital wireless network using the Code Division Multiple Access transmission.

13. The method of claim 1, wherein the receiving step comprises receiving the GPS data from a digital wireless network using a Time Division Multiple Access transmission.

14. The method of claim 1, wherein the receiving step comprises receiving GPS correction data formatted for an Internet Protocol transmission.

15. The method of claim 14, wherein the receiving step further comprises converting the GPS correction data formatted for an Internet Protocol transmission into GPS correction data formatted for a serial transmission.

16. A method of operating a surveying rover, the method comprising the step of receiving GPS correction data from a circuit switched wireless network.

17. The method of claim 16, wherein the receiving step comprises receiving GPS correction data from a circuit switched wireless network using a Code Division Multiple Access transmission.

18. The method of claim 16, wherein the receiving comprises receiving GPS correction data from a circuit switched wireless network using a Time Division Multiple Access transmission.

19. The method of claim 16, wherein the receiving step comprises receiving the GPS correction data from a circuit switched wireless network using a Frequency Division Multiple Access transmission.

20. The method of claim 16, wherein the receiving step comprises receiving the GPS correction data from a Global System for Mobil Communications circuit switched wireless network.

21. The method of claim 20, wherein the receiving step comprises receiving GPS correction data formatted for an Internet Protocol transmission from the Global System for Mobil Communications circuit switched wireless network.

22. The method of claim 16, wherein the receiving step comprises receiving the GPS correction data from an Advanced Mobile Phone Service circuit switched wireless network.

23. The method of claim 16, wherein the receiving step comprises receiving GPS correction data formatted for an Internet Protocol transmission from a circuit switched wireless network.

24. The method of claim 23, wherein the receiving step further comprises converting the GPS correction data formatted for an Internet Protocol transmission into GPS correction data formatted for a serial transmission.

25. A method of operating a surveying rover, the method comprising the steps of:
receiving GPS correction data formatted for an Internet Protocol transmission from a digital wireless network; and
generating a serial output based on the GPS correction data.

26. The method of claim 25, wherein the generating step comprises converting the GPS correction data formatted for an Internet Protocol transmission into GPS correction data formatted for a serial transmission.

27. The method of claim 25, further comprising the step of transmitting the serial output to a GPS receiver of a surveying rover.

28. The method of claim 25, wherein the receiving step comprises receiving GPS correction data formatted for an Internet Protocol transmission from a circuit switched digital wireless network.

29. The method of claim 25, wherein the receiving step comprises receiving GPS correction data formatted for an Internet Protocol transmission from a circuit switched digital wireless network using a Code Division Multiple Access transmission.

30. The method of claim 25, wherein the receiving step comprises receiving GPS correction data formatted for an Internet Protocol transmission from a circuit switched digital wireless network using a Time Division Multiple Access transmission.

31. The method of claim 25, wherein the receiving step comprises receiving GPS correction data formatted for an Internet Protocol transmission from a packet switched digital wireless network.

32. The method of claim 25, wherein the receiving step comprises receiving GPS correction data formatted for an Internet Protocol transmission from a packet switched digital wireless network using a Code Division Multiple Access transmission.

33. The method of claim 32, wherein the Code Division Multiple Access transmission comprises a Cod Division Multiple Access 1XRTT transmission.

34. The method of claim 25, wherein the receiving step comprises receiving GPS correction data formatted for an Internet Protocol transmission from a Personal Communication Services digital wireless network.

35. The method of claim 25, wherein the receiving step comprises receiving GPS correction data formatted for an Internet Protocol transmission from a Globil System for Mobil Communications digital wireless network.

36. The method of claim 25, wherein the receiving step comprises receiving GPS correction data formatted for an Internet Protocol transmission from a digital wireless network using a Code Division Multiple Access transmission.

37. The method of claim 36, wherein the Code Division Multiple Access transmission comprises a Code Division Multiple Access 1XRTT transmission.

38. The method of claim 25, wherein the receiving step comprises receiving GPS correction data formatted for an Internet Protocol transmission from a digital wireless network using a Time Division Multiple Access transmission.

39. A communications assembly for a surveying rover, the communications assembly comprising:
a computing device, and
a wireless transceiver electrically coupled to the computing device, the wireless transceiver being configured to receive GPS correction data from a digital wireless network.

40. The communications assembly of claim 39, wherein the computing device comprises a Personal Digital Assistant.

41. The communications assembly of claim 39, wherein the wireless transceiver comprises a modem.

42. The communications assembly of claim 39, wherein the wireless transceiver comprises a modem configured to communicate with a digital wireless network.

43. The communications assembly of claim 39, wherein the wireless transceiver comprises a wireless network card.

44. The communications assembly of claim 39, wherein the wireless transceiver comprises a cellular phone.

45. The communications assembly of claim 39, wherein the wireless transceiver comprises a Personal Communications Services phone.

46. The communications assembly of claim 39, wherein the wireless transceiver is configured to receive GPS correction data from a circuit switched digital wireless network.

47. The communications assembly of claim 39, wherein the wireless transceiver is configured to receive GPS correction data from a circuit switched digital wireless network using a Code Division Multiple Access transmission.

48. The communications assembly of claim 39, wherein the wireless transceiver is configured to receive GPS correction data from a circuit switched digital wireless network using a Time Division Multiple Access transmission.

49. The communications assembly of claim 39, wherein the wireless transceiver is configured to receive GPS correction data from a packet switched digital wireless network.

50. The communications assembly of claim 39, wherein the wireless transceiver is configured to receive GPS correction data from a packet switched digital wireless network using a Code Division Multiple Access transmission.

51. The communications assembly of claim 50, wherein the Code Division Multiple Access transmission comprises a Code Division Multiple Access 1XRTT transmission.

52. The communications assembly of claim 39, wherein the wireless transceiver is configured to receive GPS correction data from a Personal Communication Services digital wireless network.

53. The communications assembly of claim 39, wherein the wireless transceiver is configured to receive GPS correction data from a Global System for Mobil Communications digital wireless network.

54. The communications assembly of claim 39, wherein the wireless transceiver is configured to receive GPS correction data from a digital wireless network using a Code Division Multiple Access transmission.

55. The communications assembly of claim 54, wherein the Code Division Multiple Access transmission comprises a Code Division Multiple Access 1XRTT transmission.

56. The communications assembly of claim 39, wherein the wireless transceiver is configured to receive the GPS data from a digital wireless network using a Time Division Multiple Access transmission.

57. The communications assembly of claim 39, wherein the wireless transceiver is configured to receive GPS correction data formatted for an Internet Protocol transmission from a digital wireless network.

58. The communications assembly of claim 39, wherein the computing device is configured to convert the GPS correction data formatted for an Internet Protocol transmission into GPS correction data formatted for a serial transmission.

59. A surveying rover, comprising:
a GPS receiver configured to receive GPS data from a satellite, and
a wireless transceiver configured to receive GPS correction data from a digital wireless network.

60. The surveying rover of claim 59, further comprising a controller, wherein both the GPS receiver and the wireless transceiver are configured to communicate with the controller.

61. The surveying rover of claim 60, further comprising a Personal Digital Assistant electrically coupled to both the wireless transceiver and the controller.

62. The surveying rover of claim 61, wherein the wireless transceiver is configured to receive GPS correction data formatted for an Internet Protocol transmission.

63. The surveying rover of claim 62, wherein the Personal Digital Assistant is configured to convert the GPS correction data formatted for an Internet Protocol transmission to GPS correction data formatted for a serial transmission.

64. The surveying rover of claim 59, wherein the wireless transceiver is configured to receive GPS correction data from a circuit switched digital wireless network.

65. The surveying rover of claim 59, wherein the wireless transceiver is configured to receive GPS correction data from a circuit switched digital wireless network using a Code Division Multiple Access transmission.

66. The surveying rover of claim 59, wherein the wireless transceiver is configured to receive GPS correction data from a circuit switched digital wireless network using a Time Division Multiple Access transmission.

67. The surveying rover of claim 59, wherein the wireless transceiver is configured to receive GPS correction data from a packet switched digital wireless network.

68. The surveying rover of claim 59, wherein the wireless transceiver is configured to receive GPS correction data from a packet switched digital wireless network using a Code Division Multiple Access transmission.

69. The method of claim 68, wherein the Code Division Multiple Access transmission comprises a Code Division Multiple Access 1XRTT transmission.

70. The surveying rover of claim 59, wherein the wireless transceiver is configured to receive GPS correction data from a Personal Communication Services digital wireless network.

71. The surveying rover of claim 59, wherein the wireless transceiver is configured to receive GPS correction data from a Global System for Mobil Communications digital wireless network.

72. The surveying rover of claim 59, wherein the wireless transceiver is configured to receive GPS correction data from a digital wireless network using a Code Division Multiple Access transmission.

73. The surveying rover of claim 72, wherein the Code Division Multiple Access transmission comprises a Code Division Multiple Access 1XRTT transmission.

74. The surveying rover of claim 59, wherein the wireless transceiver is configured to receive the GPS data from a digital wireless network using a Time Division Multiple Access transmission.

75. A method of determining a GPS coordinate of a location, the method comprising:
receiving GPS data with a base station;
generating GPS correction data based on the GPS data;
transmitting the GPS correction data across a network;
accessing the network through a digital wireless network;
retrieving the GPS correction data from the digital wireless network; and
calculating the GPS coordinate of the location based on the GPS correction data.

76. The method of claim 75, wherein the generating step comprises calculating the difference between the GPS data and a known coordinate value of the location.

77. The method of claim 75, wherein the generating step comprises generating GPS correction data formatted for an Internet Protocol transmission based on the GPS data.

78. The method of claim 77, wherein the transmitting step comprises transmitting the GPS correction data formatted for an Internet Protocol transmission across a digital wireless network.

79. The method of claim 75, wherein the transmitting step comprises transmitting the GPS correction data across a publicly-accessible global network.

80. The method of claim 75, wherein the transmitting step comprises periodically transmitting the GPS correction data across a network.

81. The method of claim 75, wherein the retrieving step comprises retrieving the GPS correction data from a circuit switched digital wireless network.

82. The method of claim 75, wherein the retrieving step comprises retrieving GPS correction data from a circuit switched digital wireless network using a Code Division Multiple Access transmission.

83. The method of claim 75, wherein the retrieving step comprises retrieving GPS correction data from a circuit switched digital wireless network using a Time Division Multiple Access transmission.

84. The method of claim 75, wherein the retrieving step comprises retrieving GPS correction data from a packet switched digital wireless network.

85. The method of claim 75, wherein the retrieving step comprises retrieving GPS correction data from a packet switched digital wireless network using a Code Division Multiple Access transmission.

86. The method of claim 85, wherein the Code Division Multiple Access transmission comprises a Code Division Multiple Access 1XRTT transmission.

87. The method of claim 75, wherein the retrieving step comprises retrieving GPS correction data from a Personal Communication Services digital wireless network.

88. The method of claim 75, wherein the retrieving step comprises retrieving GPS correction data from a Global System for Mobil Communications digital wireless network.

89. The method of claim 75, wherein the retrieving step comprises retrieving GPS correction data from a digital wireless network using a Code Division Multiple Access transmission.

90. The method of claim 89, wherein the Code Division Multiple Access transmission comprises a Code Division Multiple Access 1XRTT transmission.

91. The method of claim 75, wherein the retrieving step comprises retrieving the GPS correction data from a digital wireless network using a Time Division Multiple Access transmission.

92. The method of claim 75, wherein the retrieving step comprises retrieving GPS correction data formatted for an Internet Protocol transmission.

93. The method of claim 92, wherein the retrieving step further comprises converting the GPS correction data formatted for an Internet Protocol transmission into GPS correction data formatted for a serial transmission.

94. The method of claim 75, wherein the retrieving step further comprises serially transmitting the GPS correction data to a GPS receiver of a surveying rover.

95. The method of claim 75, wherein the calculating step comprises summing the GPS correction data with GPS data received by a surveying rover.

96. A communications assembly for a surveying rover, the communications assembly comprising:
a wireless transceiver;
a processor electrically coupled to the wireless transceiver; and
a memory device electrically coupled to the processor, the memory device having stored therein a plurality of instructions, which when executed by the processor, causes the processor to:
operate the wireless transceiver to receive GPS correction data formatted for an Internet Protocol transmission from a digital wireless network, and
generate a serial output based on the GPS correction data.

97. The communications assembly of claim 96, wherein the plurality of instructions when executed by the processor further causes the processor to convert the GPS correction data formatted for an IP transmission to GPS correction data formatted for a serial transmission.

98. The communications assembly of claim 96, wherein the plurality of instructions when executed by the processor further causes the processor to transmit the serial output to a GPS receiver of the surveying rover.

99. The communications assembly of claim 96, wherein the plurality of instructions when executed by the processor further causes the processor to operate the wireless transceiver to receive GPS correction data formatted for an IP transmission from a circuit switched digital wireless network.

100. The communications assembly of claim 96, wherein the plurality of instructions when executed by the processor further causes the processor to operate the wireless transceiver to receive GPS correction data formatted for an Internet Protocol transmission from a circuit switched digital wireless network using a Code Division Multiple Access transmission.

101. The communications assembly of claim 96, wherein the plurality of instructions when executed by the processor further causes the processor to operate the wireless transceiver to receive GPS correction data formatted for an Internet Protocol transmission from a circuit switched digital wireless network using a Time Division Multiple Access transmission.

102. The communications assembly of claim 96, wherein the plurality of instructions when executed by the processor further causes the processor to operate the wireless transceiver to receive GPS correction data formatted for an Internet Protocol transmission from a packet switched digital wireless network.

103. The communications assembly of claim 96, wherein the plurality of instructions when executed by the processor further causes the processor to operate the wireless transceiver to receive GPS correction data formatted for an Internet Protocol transmission from a packet switched digital wireless network using a Code Division Multiple Access transmission.

104. The communications assembly of claim 103, wherein the Code Division Multiple Access transmission comprises a Code Division Multiple Access 1XRTT transmission.

105. The communications assembly of claim 96, wherein the plurality of instructions when executed by the processor further causes the processor to operate the wireless transceiver to receive GPS correction data formatted for an Internet Protocol transmission from a Personal Communication Services digital wireless network.

106. The communications assembly of claim 96, wherein the plurality of instructions when executed by the processor further causes the processor to operate the wireless transceiver to receive GPS correction data formatted for an Internet Protocol transmission from a Globil System for Mobil Communications digital wireless network.

107. The communications assembly of claim 96, wherein the plurality of instructions when executed by the processor further causes the processor to operate the wireless transceiver to receive GPS correction data formatted for an Internet Protocol transmission from a digital wireless network using a Code Division Multiple Access transmission.

108. The communications assembly method of claim 107, wherein the Code Division Multiple Access transmission comprises a Code Division Multiple Access 1XRTT transmission.

109. The communications assembly of claim 96, wherein the plurality of instructions when executed by the processor further causes the processor to operate the wireless transceiver to receive GPS correction data formatted for an Internet Protocol transmission from a digital wireless network. using a Time Division Multiple Access transmission.

110. The communications assembly of claim 96, wherein the wireless transceiver comprises a modem.

111. The communications assembly of claim 96, wherein the wireless transceiver comprises a modem configured to communicate with a digital wireless network.

112. The communications assembly of claim 96, wherein the wireless transceiver comprises a wireless network card.

113. The communications assembly of claim 96, wherein the wireless transceiver comprises a cellular phone.

114. The communications assembly of claim 96, wherein the wireless transceiver comprises a Personal Communications Services phone.

115. An article comprising:
a computer-readable signal-bearing medium having a plurality of instructions, which when executed by a processor, causes the processor to:
operate a wireless transceiver to receive GPS correction data formatted for an IP transmission from a digital wireless network, and
generate a serial output based on the GPS correction data.

116. The article of claim 115, wherein the medium is a recordable data storage medium.

117. The article of claim 115, wherein the medium is selected from a group consisting of magnetic, optical, biological and atomic data storage media.

118. The article of claim 115, wherein the medium is a modulated carrier signal.

119. The article of claim 115, wherein the plurality of instructions when executed by the processor further causes the processor to operate the wireless transceiver to receive GPS correction data formatted for an IP transmission from a digital wireless network selected from a group consisting of a circuit switched digital wireless network, a packet switched digital wireless network, a digital wireless network using a Code Division Multiple Access transmission, a digital wireless network using a Time Division Multiple Access transmission, a Global System for Mobil Communications digital wireless network, and a Personal Communication Services digital wireless network.
